(19) United States
(12) Patent Application Publication
(10) Pub. No.: US 2017/0185128 A1
(43) Pub. Date: Jun. 29, 2017

(54) Method and apparatus to control number of cores to transition operational states

(71) Applicant: INTEL CORPORATION, Santa Clara, CA (US)

(72) Inventors: Venkatesh Ramamurthy, Hillsboro, OR (US); Ripan Das, Beaverton, OR (US)

(21) Appl. No.: 14/757,561

(22) Filed: Dec. 24, 2015

(51) Int. Cl. G06F 1/32

(52) U.S. Cl. CPC G06F 1/3203

(57) ABSTRACT

An electronic device may be provided that includes logic, at least a portion which is hardware, to receive a plurality of transition requests within a configurable moving time period and to block a clock signal to one or more of the plurality of cores based on the received transition requests.

### BACKGROUND

1. Field

Embodiments may relate to controlling a number of cores to transition operational states during a configurable moving time window.

2. Background

Electronic devices may include integrated circuits having a plurality of cores. Each of the cores may transition between different states or modes of operation. However, this may result in power delivery/management issues.

### BRIEF DESCRIPTION OF THE DRAWINGS

Embodiments may be described in detail with reference to the following drawings in which like reference numerals refer to like elements wherein:

FIG. 1 shows an electronic system according to an example embodiment;

FIG. 2 shows an integrated circuit according to an example embodiment;

FIG. 3 shows hardware to control transitioning of cores according to an example embodiment;

FIG. 4 is a state diagram showing state transitions of signals according to an example embodiment; and

FIG. 5 is a flowchart showing controlling operational states of cores according to an example embodiment.

### DETAILED DESCRIPTION

Any reference to “one embodiment” or “an embodiment” means that a particular feature, structure, or characteristic described in connection with the embodiment is included in at least one embodiment. The appearances of the phrases “in one embodiment” and “in an embodiment” in various places in the specification are not necessarily all referring to the same embodiment. Further, different embodiments may be combined with other embodiments.

Embodiments may relate to controlling a number of compute cores (hereafter called cores) to transition operational states during a moving time window. A computer core is any processing engine that reads and executes instructions or performs fixed processing, such as CPU cores, Graphics cores, etc.

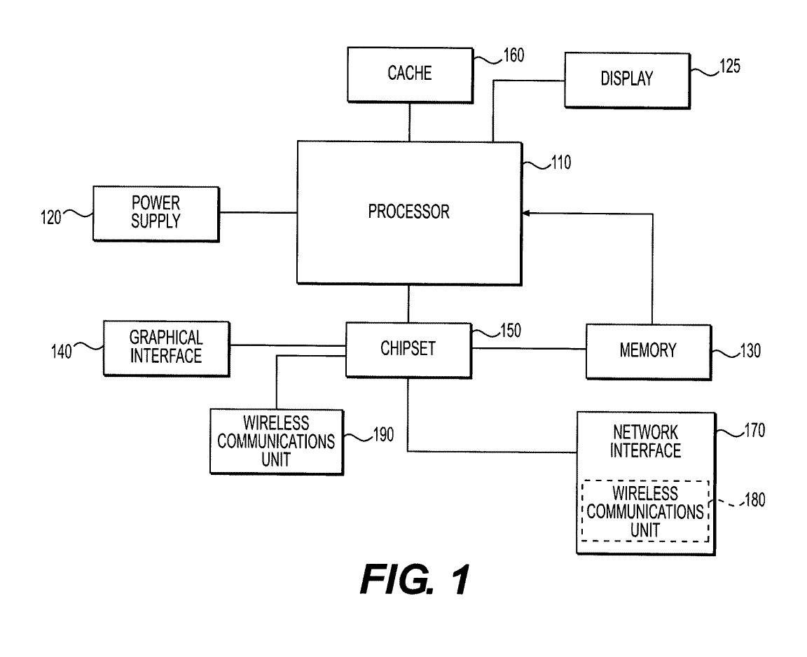

FIG. 1 shows an electronic system according to an example embodiment. Other embodiments and configurations may also be provided.

FIG. 1 shows an electronic system 100 that includes a processor 110, a power supply 120, a display 125 and a memory 130. The processor 110 may include an arithmetic logic unit and an internal cache, for example. The processor 110 may perform operations by using received instructions, such as instructions received via a computer-readable medium (or machine-readable medium). The processor 110 may correspond to any previously described processor.

The above-described features may be provided within the electronic system 100 shown in FIG. 1.

The system 100 may also include a graphical interface 140, a chipset 150, a cache 160, a network interface 170 and a wireless communication unit 180, which may be incorporated within the network interface 170. Alternatively or additionally, a wireless communications unit 190 may be coupled to the processor 110, and a direct connection may exist between the memory 130 and the processor 110.

The processor 110 may be a central processing unit (CPU), a microprocessor or any other type of processing or computing circuit and may be included on a chip die with all or any combination of the remaining features, or one or more of the remaining features may be electrically coupled to the microprocessor die through known connections and interfaces. The connections that are shown are merely illustrative as other connections between or among the elements depicted may exist depending, for example, on chip platform, functionality, or application requirements.

In at least one embodiment, the processor 110 may be provided on a chip, such as a system on chip. The processor may include components such as a memory controller and a graphics device, etc. The chip may be a multi-core chip. For example, the chip may contain four separate cores.

In at least one embodiment, a computer-readable medium (or machine-readable medium) may store a program for controlling operational states of the different cores. The program may include instructions or code.

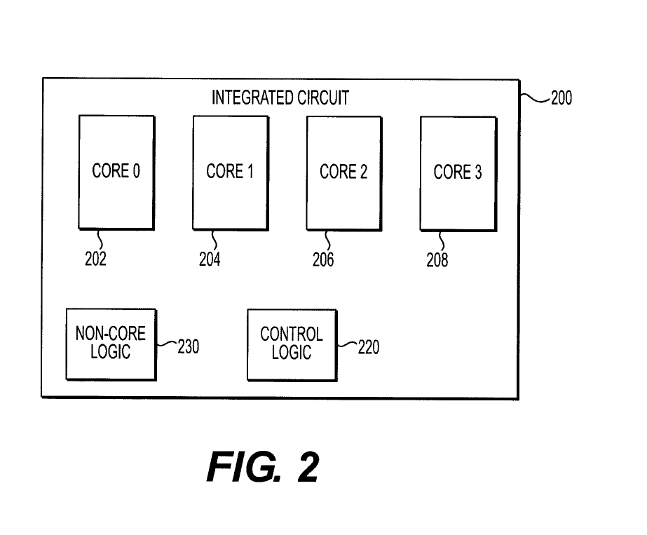

FIG. 2 shows an integrated circuit according to an example embodiment. Other embodiments and configurations may also be provided.

FIG. 2 shows an integrated circuit 200. The integrated circuit 200 may be a die or a chip. The integrated circuit may include a plurality of cores. Each core may correspond to a separate Central Processing Unit (CPU) or a separate processor.

FIG. 2 shows the integrated circuit 200 includes four (4) cores, namely Core0 202, Core1 204, Core2 206 and Core3 208. Other numbers of cores may also be provided.

The integrated circuit 200 may also include control logic 220 and non-core logic 230. As will be described below, the control logic 200 may be used in conjunction with the cores 202, 204, 206, 208. For example, the control logic 220 may be used to control operations of the cores 202, 204, 206, 208. In at least one embodiment, the control logic 220 may control operations states of the cores. In at least one embodiment, the control logic may determine whether to block a clock signal to one of the cores based on a determination of a total number of transition requests.

In at least one embodiment, the control logic 220 may include a phase locked loop (PLL) circuit that provides a separate clock signal to each of the cores 202, 204, 206, 208. The clock signal allows each of the cores to operate. The control logic may also be referred to a Processor Control Unit (PCU) that may control the clock signal being provided to the cores (or processors). In at least one arrangement, multiple PLL circuits may be part of a clock generation unit (or block). In at least one arrangement, PLL circuits (with a clock generation scheme) may be provided local to the cores (or processor) to help with reduced clock skews.

The control logic 220 may include logic, at least a portion of which is hardware. The non-control logic 220 may include logic, at least a portion of which is hardware.

The non-core logic 230 may be used for other operations. The non-core logic 230 may include logic to monitor or control clocks (or clock signals), input-output (10) devices (such as PCIe root complex, System DMA engine, voltage, temperature, power and energy management etc.) for the cores (or processor cores).

During operation, the cores may transition between different operational states or modes, such as an idle mode (Clock Gated or C1) and an Active mode (C0). For example, an operating system (OS) based on CPU core utilization may determine that a particular core may transition into a low power state and issue a special CPU instruction that triggers the power management unit in the non-core logic (or Processor Control Unit (PCU)) to enter the low power state. Exiting of the low power state may be done by an interrupt (such as a timer, device, etc.).

Each of the cores may separately transition between states/modes. In one example, the core 202 may transition from an idle state to an active state. In another example, the core 202 may transition from the active state to the idle state. The transition of each core may be independent and may happen at any time.

However, a transient step load (or step load transient) may occur when a plurality of cores transition between different operational states during a specific and short time period. For example, a large transient step load may be a large current draw that occurs when a plurality of cores transition from an idle state to an active state within a short time period (such as a few 100 nsec). The large transient step load may also occur when a plurality of cores transition from the active state to the idle state within the short time period.

For example, when the cores (i.e., processor cores) operate (i.e., execute instructions) then changes in the logic state may occur in standard cells, causing a required current draw from the power supply. The current draw may be referred to as a load. When multiple cores transition from idle (to active) at a same time, then a large step load (or current draw from power supply) may occur.

A single core that transitions from idle to active may cause an approximately ˜10 A current step within a short time period of 200 nsec, for example. If more than one core is transitioning within the same time period (of 200 nsec), then an amplitude of the step load may be directly proportional to the number of cores that are transitioning. A large and fast step load (i.e., current draw) from the power supply may result in a voltage droop since the power supply may not respond that quickly. The voltage droop may cause logic failure in silicon (or the die) since the transistors have a minimum voltage for transition states. Power supplies may be designed to hold the voltage steady for a given current draw in a given time window. In order to handle a large current draw, voltage regulators may have to be over-designed, and thereby increasing the cost.

Embodiments may control the power delivery step load current by limiting a total number of cores to transition within a time window (or moving time window). For example, a CPU Power Management unit (PCU) may limit a total number of cores that transition from Idle (Clock Gated) to Active (C0) during a time window (or moving time window). For example, the control logic may limit the total number of core transitions to be 2 cores within 200 nsec (i.e., the moving time window). Duration of the moving time window is configurable and may vary by platform design or configuration setting via BIOS or OS.

Additionally and/or alternatively, the CPU PCU (or control logic) may limit a total number of cores that transition from Active (C0) to Idle (Clock Gated—C1) during a time window (or moving time window).

By limiting the total number of cores to transition during a predetermined moving time window, an amplitude of a step load current (di/dt) may be reduced.

The limit of the total number of cores to transition within a moving time window may be determined based on power delivery step load (di/dt) design limits.

Embodiments may provide a hardware (and/or logic of which a part is hardware) to monitor a total number of cores requesting to transition between Idle and Active (or vice versa) within a programmable moving time window. If the total number of cores requesting to transition exceeds a programmable threshold, then the hardware (and/or logic of which is part hardware) may prevent (or block) one of more cores from transitioning within the time window. The core(s) may be prevented from transitioning by withholding a clock signal to the core(s). These features may also be performed by a program that limits a total number of cores from transitioning.

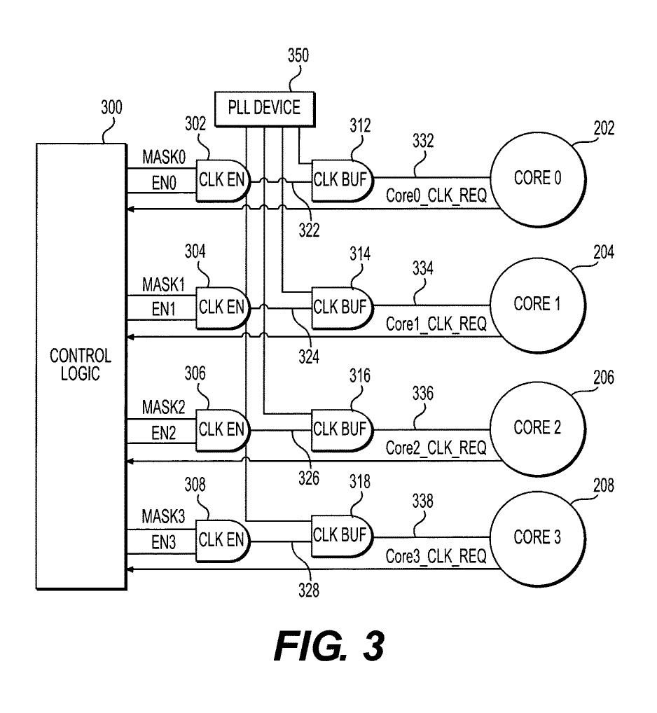

FIG. 3 shows hardware to control transitioning of cores according to an example embodiment. Other configurations and embodiments may also be provided.

The elements shown in FIG. 3 may be provided on the integrated circuit 200 (of FIG. 2).

FIG. 3 shows the four (4) cores, namely Core0 202, Core1 204, Core2 206 and Core3 208. Each core may be separately operated. Each core may separately and independently request to transition (to a different operational state). An operating system (OS) based on CPU core utilization may determine that a particular core can transition into low power state and issue a special CPU instruction that triggers that Power Management Unit (PMU) in the non-core control logic (or Processor Control Unit (PCU)) to enter the low power state. Exiting of the low power state may be done by an interrupt (such as a timer, device, etc.).

FIG. 3 also shows control logic 300, a phase locked loop (PLL) device 350 and logical AND gates 302, 304, 306, 308, 312, 314, 316, and 318.

Each core may separately provide a clock request CLK_REQ to the control logic in order to request to transition from idle to active. The clock request is only provided when a transition is desired for the specific core. Upon receiving the clock request signal, the control logic may determine a total number of cores requesting to transition within a moving time window. If the determined number of cores exceeds a programmable threshold, then a clock signal from the PLL device 350 may be prevented from driving at least one core (based on the threshold). This may prevent (or block) at least one of the cores from transitioning within the time window.

For example, the Core0 202 may provide a clock request signal Core0_CLK_REQ along a signal line to the control logic 300. The Core1 204 may provide a clock request signal Core1_CLK_REQ along a signal line to the control logic 300. The Core2 206 may provide a clock request signal Core2_CLK_REQ along a signal line to the control logic 300. The Core3 208 may provide a clock request signal Core3_CLK_REQ along a signal line to the control logic 300. Accordingly, each core may separately notify the control logic 300 when the respective core desires to transition.

In response to receiving the clock request CLK_REQ from a specific core, the control logic 300 may provide an enable (EN) signal CLK_Enable for the respective core. For example, in response to receiving the clock request signal Core0_CLK_REQ, the control logic 300 may provide the enable signal EN0 to the gate 302. In response to receiving the clock request signal Core1_CLK_REQ, the control logic 300 may provide the enable signal EN1 to the gate 304. In response to receiving the clock request signal Core2_CLK_REQ, the control logic 300 may provide the enable signal EN2 to the gate 306. In response to receiving the clock request signal Core3_CLK_REQ, the control logic 300 may provide the enable signal EN3 to the gate 308.

The control logic 300 may also provide mask signals based on a current state of all the mask signals (relating to the plurality of cores) and a configurable policy of a total number of cores that are allowed to transition if a clock request transition is provided. For example, the mask signal may be provided based on a finite state machine. The total number of cores that are allowed to transition within a time window may be pre-programmed into the control logic or configurable by firmware or software settings.

The mask signals may be used to determine whether to enable the clock or not. For example, if an enable signal is HIGH and the mask bit is 0 (or low) then the clock may be disabled. The mask bits may be generated based on a finite state machine at every clock cycle which is a function of platform policy and previous states of mask bits and also a clock request signal state. The finite state machine may operate in part based on a logic table.

The control logic 300 may provide a mask signal mask0 relating to the Core0 202. The control logic 300 may provide a mask signal mask1 relating to the Core1 204. The control logic 300 may provide a mask signal mask2 relating to the Core2 206. The control logic 300 may provide a mask signal mask3 relating to the Core3 208.

The gate 302 may receive the mask0 signal and the EN0 signal. The gate 302 may perform a logical AND operation based on the mask0 signal and the EN0 signal, and provide an output signal 322 to the clock buffer 312. The gate 304 may receive the mask1 signal and the EN1 signal. The gate 304 may perform a logical AND operation based on the mask1 signal and the EN1 signal, and provide an output signal 324 to the clock buffer 314. The gate 306 may receive the mask2 signal and the EN2 signal. The gate 306 may perform a logical AND operation based on the mask2 signal and the EN2 signal, and provide an output signal to the clock buffer 316. The gate 308 may receive the mask3 signal and the EN3 signal. The gate 308 may perform a logical AND operation based on the mask3 signal and the EN3 signal, and provide an output signal 328 to the clock buffer 318.

Accordingly, the output of the respective gates 302, 304, 306 and 308 is based on the mask signal and the clock request signal. The respective outputs may then be used to block the clock signal for a respective one of the cores.

FIG. 3 shows the PLL device 350 that provides a clock signal. The clock signal may be separately provided to each of the cores. However, clock buffers may be provided to block the clock signal from reaching the respective cores.

For example, the clock buffer 312 may receive the clock signal (from PLL device 150) and the output signal 322 from the gate 302. The clock buffer 312 may perform a logical AND operation on the two inputs and provide an output signal 332 to the Core0 202. The clock buffer 314 may receive the clock signal (from PLL device 150) and the output signal 334 from the gate 304. The clock buffer 314 may perform a logical AND operation on the two inputs and provide an output signal 334 to the Core1 204.

The clock buffer 316 may receive the clock signal (from PLL device 150) and the output signal 326 from the gate 306. The clock buffer 316 may perform a logical AND operation on the two inputs and provide an output signal 336 to the Core2 206. The clock buffer 318 may receive the clock signal (from PLL device 150) and the output signal 328 from the gate 308. The clock buffer 318 may perform a logical AND operation on the two inputs and provide an output signal 338 to the Core3 208.

In summary, if the mask signal for a respective core is 0, then the clock buffer may block the clock signal from being provided to the respective core. On the other hand, if the mask signal for a respective core is 1 and the enable signal EN is 1, then the clock signal may be provided through the clock buffer to the respective core. The core may then perform its proper transition and perform other core operations.

The control logic may de-assert the mask signal for one or more cores when the number of cores requesting transition drops below the threshold for the moving time window. For example, if three cores request a transition from idle to active state in Time t0, and the policy is to allow only two (2) cores in a 200 nsec moving time window, then in time t0 only two cores are enabled (i.e., the Mask is 1). For the next window (or 200 ns), the third core is blocked. After 200 nsec (t0+200 nsec), the control logic may deassert the mask and the third core may exit the idle state to enter the active state.

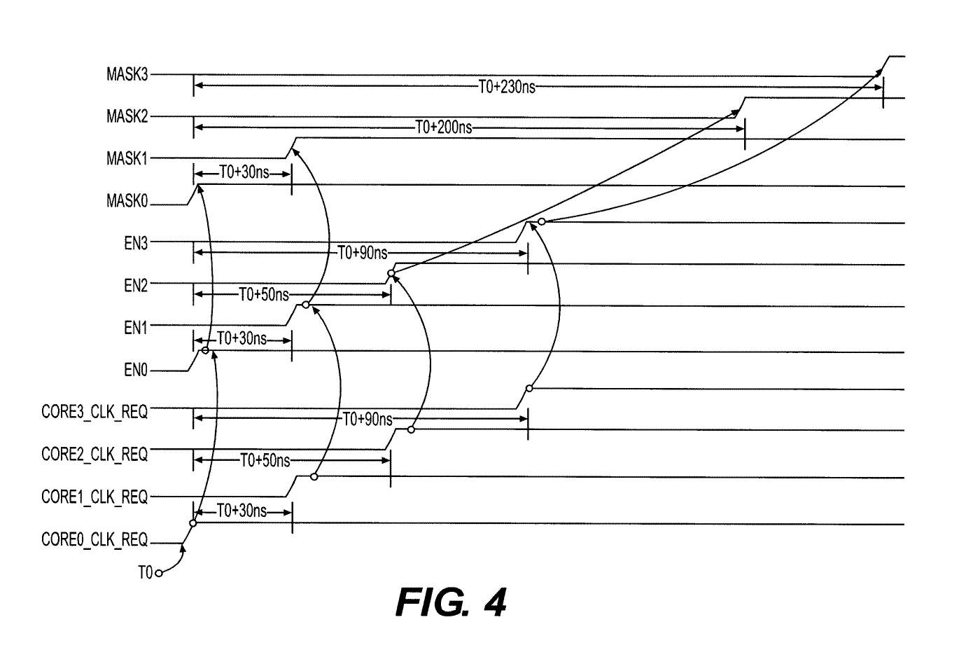

FIG. 4 is a diagram showing the state transitions of signals transmitted in an example embodiment. Other embodiments may also be provided. FIG. 4 will be described with regard to transitions from Idle to Active. However, the embodiment (and description with respect to FIG. 4) may be provided with respect to transitions from Active to Idle.

FIG. 4 shows the state transitions of signals transmitted in an example embodiment involving four cores and a policy wherein only two cores can transition from the Idle state to the Active state within a moving time window of 200 ns. It is assumed no CLK_REQ signal was asserted from any core prior to the time t0=0.

At time t0=0, Core0 requests transition from Idle to Active by asserting the clock request Core0_CLK_REQ signal. In response to receiving the Core0_CLK_REQ signal, the control logic 300 provides the enable signal EN0. Because less than two (at this time, none) of the remaining cores have asserted their respective CLK_REQ signals within the moving time window of 200 ns, the control logic 300 provides the signal Mask0.

At time t0+30 ns, Core1 requests transition from Idle to Active by asserting the clock request Core1_CLK_REQ signal. In response to receiving the Core1_CLK_REQ signal, the control logic 300 provides the enable signal EN1. Because less than two (at this time, only Core0) of the remaining cores have asserted their respective CLK_REQ signals within the moving time window of 200 ns, the control logic 300 provides the signal Mask1.

At time t0+50 ns, Core2 requests transition from Idle to Active by asserting the clock request Core2_CLK_REQ signal. In response to receiving the Core2_CLK_REQ signal, the control logic 300 provides the enable signal EN2. Because two (at this time, Core0 and Core1) of the remaining cores have asserted their respective CLK_REQ signals within the moving time window of 200 ns, the control logic 300 does not provide the signal Mask2 until a condition exists wherein less than two CLK_REQ signals have been asserted within the preceding 200 ns. Because this condition does not exist until time=t0+200 ns, the control logic provides the signal Mask2 at time=t0+200 ns.

At time t0+90 ns, Core3 requests transition from Idle to Active by asserting the clock request Core3_CLK_REQ signal. In response to receiving the Core3_{—} CLK_{—} REQ signal, the control logic provides the enable signal EN3. Because three (at this time, Core0, Core1, and Core2) of the remaining cores have asserted their respective CLK_REQ signals within the moving time window of 200 ns, the control logic 300 does not provide the signal Mask3 until a condition exists wherein less than two CLK_REQ signals have been asserted within the preceding 200 ns. Because this condition does not exist until time=t0+230 ns, the control logic provides the signal Mask3 at time=t0+230 ns.

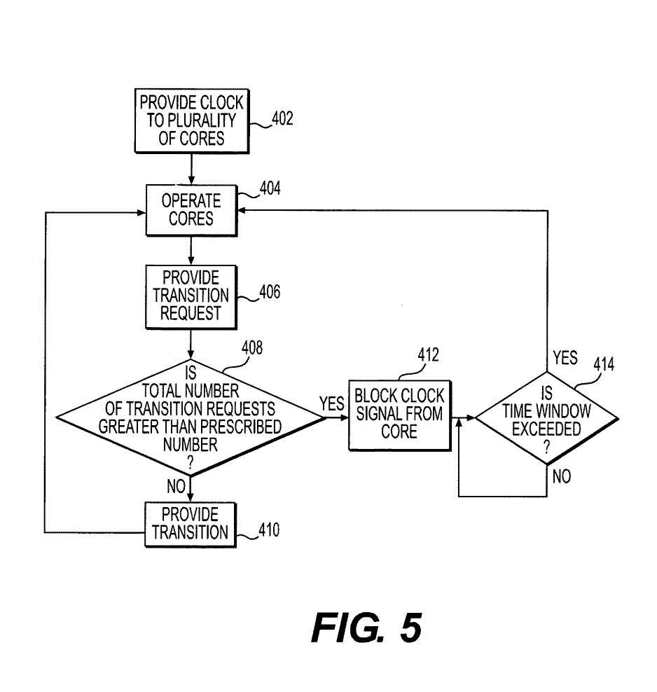

FIG. 5 is a flowchart showing controlling operational states of cores according to an example embodiment. Other operations, orders of operation and embodiments may also be used.

More specifically, operation 402 includes to provide a clock to a plurality of cores. For example, a clock device may provide a clock signal to each of a plurality of cores.

Operation 404 includes to operate the plurality of cores. For example, the cores may operate to perform their respective operations.

Operation 406 includes to provide a transition request. For example, any one of a plurality of cores may provide a transition request if the core is to transition between idle and active.

Operation 408 is a determination of whether a total number of transition requests is greater than a prescribed number. For example, control logic may determine whether the total number of received transition requests (within a moving time window) exceeds a prescribed number. The prescribed number may be previously programmed. In at least one embodiment, the control logic may maintain a net sum of transitions between idle to active and active to idle transition and use only the net sum of transitions to determine if it exceeds the prescribed number.

If the determination is NO in operation 408, then operations may proceed to operation 404. For example, if the determination is NO, then the transitions may occur and the cores may operate accordingly.

If the determination is YES in operation 408, then the clock signal may be blocked from the core in operation 412. For example, if the determination is YES in operation 408, then the generated clock signal may be blocked from one of the cores. As such, the core will be unable to transition during the respective time window. After the time window expires, even if there is no change in the clock, the clock request bit will go high and allow the enable EN and Mask.

Operation 414 includes a determination of whether the time window has been exceeded. If the determination is NO, then the operation continues until the determination is YES. If the determination is YES, then the cores may operate accordingly.

The above described embodiments may occur within logic, at least a portion of which is hardware. Additionally and/or alternatively, instructions or code may be provided to a memory from a machine-readable medium, or an external storage device accessible via a remote connection (e.g. over a network via an antenna and/or network interface) providing access to one or more electronically-accessible media, etc. A machine-readable medium may include any mechanism that provides (i.e., stores and/or transmits) information in a form readable by a machine (e.g., a computer). For example, a machine-readable medium may include random access memory (RAM), read only memory (ROM), magnetic or optical storage medium, flash memory devices, electrical, optical, acoustical or other form of propagated signals (e.g., carrier waves, infrared signals, digital signals), etc. In alternative embodiments, hard-wired circuitry may be used in place of or in combination with the instructions or code, and thus embodiments are not limited to any specific combination of hardware circuitry and software instructions.

The program may include code or instructions to perform any of the operations or functions performed in embodiments previously discussed above.

Features of the above described embodiments may be provided in code segments or instructions to perform tasks. The code segments or tasks may be stored in a processor readable medium (or machine-readable medium) or transmitted by a computing data signal in a carrier wave over a transmission medium or communication link. The processor readable medium, machine readable medium and/or computer readable medium may include any medium that can store or transfer information.

The following examples pertain to further embodiments.

Example 1 is an electronic device comprising: logic, at least a portion which is hardware, to receive a plurality of transition requests from a plurality of cores within a configurable moving time period and to block a clock signal to one or more of the plurality of cores based on the received transition requests.

In Example 2, the subject matter of Example 1 can optionally include a clock device to provide the clock signal to each of the plurality of cores.

In Example 3, the subject matter of any one of Examples 1-2 can optionally include the logic to determine a total number of transition requests within the configurable moving time period.

In Example 4, the subject matter of Example 1 and Example 3 can optionally include the logic to block the clock signal to the one or more of the plurality of cores when the total number of transition requests is determined to exceed a prescribed threshold.

In Example 5, the subject matter of Example 1 and Example 4 can optionally include the prescribed threshold is programmable.

In Example 6, the subject matter of Example 1 can optionally include the logic to block the clock signal to the one or more of the plurality of cores when a total net sum of the transition requests exceeds a prescribed threshold.

In Example 7, the subject matter of any one of Examples 1-6 can optionally include one or more of the plurality of cores to perform a transition to a different operational state when the clock signal is blocked from one or more of the plurality of cores.

In Example 8, the subject matter of Example 1 and Example 7 can optionally include the transition is from an active state to an idle state.

In Example 9, the subject matter of Example 1 and Example 7 can optionally include the transition is from an idle state to an active state.

In Example 10, the subject matter of any one of Examples 1-9 can optionally include the logic is provided on an integrated circuit.

Example 11 is an electronic system comprising: a power supply to supply power; and an integrated circuit having a plurality of cores and control logic to receive a plurality of transition requests within a configurable moving time period and to block a clock signal to one or more of the plurality of cores based on the received transition requests.

In Example 12, the subject matter of Example 11 can optionally include the integrated circuit includes a clock device to provide the clock signal to each of the plurality of cores.

In Example 13, the subject matter of any one of Examples 11-12 can optionally include the control logic to determine a total number of transition requests within the configurable moving time period.

In Example 14, the subject matter of Example 11 and Example 13 can optionally include the control logic to block the clock signal to the one or more of the plurality of cores when the total number of transition requests is determined to exceed a prescribed threshold.

In Example 15, the subject matter of Example 11 can optionally include the control logic to block the clock signal to the one or more of the plurality of cores when a total net sum of the transition requests exceeds a prescribed threshold.

In Example 16, the subject matter of any one of Examples 11-15 can optionally include one or more of the plurality of cores to perform a transition to a different operational state when the clock signal is blocked from one or more of the plurality of cores.

In Example 17, the subject matter of Example 11 and Example 16 can optionally include the transition is from an active state to an idle state.

In Example 18, the subject matter of Example 11 and Example 16 can optionally include the transition is from an idle state to an active state.

Example 19 is an electronic device comprising: a plurality of cores; receiving means for receiving a plurality of transition requests from the plurality of cores within a configurable moving time period; and blocking means for blocking a clock signal to one or more of the plurality of cores based on the plurality of transition requests.

In Example 20, the subject matter of Example 19 can optionally include clocking means for providing the clock signal to each of the plurality of cores.

In Example 21, the subject matter of any one of Examples 19-20 can optionally include determining means for determining a total number of transition requests within the configurable moving time period.

In Example 22, the subject matter of Example 20 and Example 21 can optionally include the blocking mean for blocking the clock signal to one or more of the plurality of cores when the total number of transition requests is determined to exceed a prescribed threshold.

In Example 23, the subject matter of Example 19 can optionally include the blocking means for blocking the clock signal to the one or more of the plurality of cores when a total net sum of the transition requests exceeds a prescribed threshold.

In Example 24, the subject matter of any one of Examples 19-23 can optionally include one or more of the plurality of cores to perform a transition to a different operational state when the clock signal is blocked from one or more of the plurality of cores.

In Example 25, the subject matter of Example 19 and Example 24 can optionally include the transition is from an active state to an idle state.

In Example 26, the subject matter of Example 19 and Example 24 can optionally include the transition is from an idle state to an active state.

Example 27 is a method of controlling an electronic device comprising: receiving a plurality of transition requests from a plurality of cores within a configurable moving time window; and blocking a clock signal to one or more of the plurality of cores based on the received plurality of transition requests.

In Example 28 the subject matter of Example 27 can optionally include providing the clock signal to each of the plurality of cores.

In Example 29, the subject matter of any one of Examples 27-28 can optionally include determining a total number of transition requests within the configurable moving time period.

In Example 30, the subject matter of Example 27 and Example 29 can optionally include blocking the clock signal includes blocking the clock signal to the one or more of the plurality of cores when the total number of transition requests is determined to exceed a prescribed threshold.

In Example 31, the subject matter of Example 27 can optionally include blocking the clock signal includes blocking the clock signal to the one or more of the plurality of cores when a total net sum of the transition requests exceeds a prescribed threshold.

In Example 32, the subject matter of any one of Examples 27-31 can optionally include one or more of the plurality of cores to perform a transition when the clock signal is blocked to another one of the cores.

In Example 33, the subject matter of Example 27 and Example 32 can optionally include the transition is from an active state to an idle state.

In Example 34, the subject matter of Example 27 and Example 32 can optionally include the transition is from an idle state to an active state.

Example 35 is a machine-readable medium comprising one or more instructions that when executed cause a processor to perform one or more operations to: receive a plurality of transition requests from a plurality of cores within a configurable moving time window; and block a clock signal to one or more of the plurality of cores based on the received plurality of transition requests.

In Example 36, the subject matter of Example 35 can optionally include the one or more operations to further provide the clock signal to each of the plurality of cores.

In Example 37, the subject matter of any one of Examples 35-36 can optionally include the one or more operations to further determine a total number of transition requests within the configurable moving time period.

In Example 38, the subject matter of Example 35 and Example 37 can optionally include to block the clock signal includes to block the clock signal to the one or more of the plurality of cores when the total number of transition requests is determined to exceed a prescribed threshold.

In Example 39, the subject matter of Example 35 can optionally include to block the clock signal includes to block the clock signal to the one or more of the plurality of cores when a total net sum of the transition requests exceeds a prescribed threshold.

In Example 40, the subject matter of any one of Examples 35-39 can optionally include one or more of the plurality of cores to perform a transition when the clock signal is blocked to another one of the cores.

In Example 41, the subject matter of Example 35 and Example 40 can optionally include the transition is from an active state to an idle state.

In Example 42, the subject matter of Example 35 and Example 40 can optionally include the transition is from an idle state to an active state.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electronic device comprising:
logic, at least a portion which is hardware, to receive a plurality of transition requests from a plurality of cores within a configurable moving time period and to block a clock signal to one or more of the plurality of cores based on the received transition requests.

2. The electronic device of claim 1, further comprising a clock device to provide the clock signal to each of the plurality of cores.

3. The electronic device of claim 1, wherein the logic to determine a total number of transition requests within the configurable moving time period.

4. The electronic device of claim 3, wherein the logic to block the clock signal to the one or more of the plurality of cores when the total number of transition requests is determined to exceed a prescribed threshold.

5. The electronic device of claim 1, wherein one or more of the plurality of cores to perform a transition to a different operational state when the clock signal is blocked from one or more of the plurality of cores.

6. The electronic device of claim 5, wherein the transition is from an active state to an idle state.

7. The electronic device of claim 5, wherein the transition is from an idle state to an active state.

8. The electronic device of claim 1, wherein the logic is provided on an integrated circuit.

9. An electronic system comprising:
a power supply to supply power; and
an integrated circuit having a plurality of cores and control logic to receive a plurality of transition requests within a configurable moving time period and to block a clock signal to one or more of the plurality of cores based on the received transition requests.

10. The electronic system of claim 9, wherein the integrated circuit includes a clock device to provide the clock signal to each of the plurality of cores.

11. The electronic system of claim 9, wherein the control logic to determine a total number of transition requests within the configurable moving time period.

12. The electronic system of claim 11, wherein the control logic to block the clock signal to the one or more of the plurality of cores when the total number of transition requests is determined to exceed a prescribed threshold.

13. The electronic system of claim 9, wherein one or more of the plurality of cores to perform a transition to a different operational state when the clock signal is blocked from one or more of the plurality of cores.

14. An electronic device comprising:
a plurality of cores;
receiving means for receiving a plurality of transition requests from the plurality of cores within a configurable moving time period; and
blocking means for blocking a clock signal to one or more of the plurality of cores based on the plurality of transition requests.

15. The electronic device of claim 14, further comprising clocking means for providing the clock signal to each of the plurality of cores.

16. The electronic device of claim 14, further comprising determining means for determining a total number of transition requests within the configurable moving time period.

17. The electronic device of claim 16, wherein the blocking mean for blocking the clock signal to one or more of the plurality of cores when the total number of transition requests is determined to exceed a prescribed threshold.

18. The electronic device of claim 14, wherein one or more of the plurality of cores to perform a transition to a different operational state when the clock signal is blocked from one or more of the plurality of cores.

19. The electronic device of claim 18, wherein the transition is from an active state to an idle state.

20. The electronic device of claim 18, wherein the transition is from an idle state to an active state.
